(19) United States
(12) Patent Application Publication
(10) Pub. No.: US 2009/0321696 A1
(43) Pub. Date: Dec. 31, 2009

(54) LIFTING DEVICE

(75) Inventors: Holger Birkholz, Faulbach (DE); Robert Miltenberger, Miltenberg (DE); Ralf Natterer, Momlingen (DE); Gerhard Trunk, Collenberg (DE)

Correspondence Address: INTELLECTUAL PROPERTY GROUP;FREDRIKSON & BYRON, P.A., 200 SOUTH SIXTH STREET, SUITE 4000, MINNEAPOLIS, MN, 55402, US

(73) Assignee: Haacon Hebetechnik GmbH, Freudenberg (DE)

(21) Appl. No.: 12/375,714

(22) PCT Filed: Jul. 12, 2007
(86) PCT No.: PCT/DE2007/001247

§ 371 Date: Jan. 30, 2009

(30) Foreign Application Priority Data
Jul. 31, 2006 (DE) 10 2006 035 919.4

(51) Int. Cl. B60S 9/06

(52) U.S. Cl. 254/419

(57) ABSTRACT

The invention relates to a lifting device (10), in particular a semitrailer support or the like, comprising a shank tube (11) and a support tube (12) which is movable with respect to the shank tube, wherein on the shank tube a lifting gear mechanism (26) is arranged which comprises an input shaft arrangement (27) for connecting a drive device and an output shaft arrangement (28) for driving a lifting spindle (20) which is arranged within the support tube, wherein the input shaft arrangement and the output shaft arrangement each comprise at least one large-diameter gearwheel (70, 80) and one small-diameter gearwheel (62, 81) which can be put in force-fitting engagement with one another to generate different transmission ratios, wherein the input shaft arrangement comprises a hollow shaft (86) supported in a gear housing (68), and an axially movable gearshift shaft (85) which is arranged coaxially with respect to the hollow shaft and which is supported in the gear housing, wherein the hollow shaft serves for the rotationally fixed arrangement of the large-diameter gearwheel (78), and the gearshift shaft serves for the rotationally fixed arrangement of the small-diameter gearwheel (pinion) (62), and the hollow shaft and the gearshift shaft are provided with engagement devices which can be put in coupling engagement by means of axial movement in order to change the transmission ratio.

The present invention relates to a lifting device, in particular a semitrailer support or the like, comprising a shank tube and a support tube which is movable with respect to the shank tube, wherein on the shank tube a lifting gear mechanism is arranged which comprises an input shaft arrangement for connecting a drive device and an output shaft arrangement for driving a lifting spindle which is arranged within the support tube, wherein the input shaft arrangement and the output shaft arrangement each comprise at least one large-diameter gearwheel and one small-diameter gearwheel which can be put in force-fitting engagement with one another to generate different transmission ratios.

Lifting devices of the type mentioned above are used in the application as semitrailer supports, for example, as height-adjustable support devices for so-called “semitrailers”, when they are parked independently from a tractive vehicle. For operating the lifting devices, in particular a simple handling as well as a construction of the lifting devices which is as compact as possible have proved to be advantageous. For both, the design of the lifting gear mechanism is of significant influence since the lifting gear mechanism, on the one hand, by its positioning provided outside on the shank tube, contributes significantly to determine the outer dimensions of the lifting device, and, on the other hand, because of the construction of the lifting gear mechanism as a gear shift mechanism, a simple and safe execution of the shifting operation for selecting the most suitable transmission ratio is of great importance.

The present invention is hence based on the object to propose a lifting device, the lifting gear mechanism of which comprises, on the one hand, a construction which is as compact as possible and which projects insignificantly beyond the outer dimensions of the lifting device, and, on the other hand, allows a simple operation, in particular with respect to the execution of the shifting operation.

This object is solved by a lifting device with the features of the claim 1.

In the lifting device according to the invention, the input shaft arrangement comprises a hollow shaft supported in a gear housing and an axially movable gearshift shaft which is arranged coaxially with respect to the hollow shaft, and which is supported in the gear housing, wherein the hollow shaft serves for the rotationally fixed arrangement of the large-diameter gearwheel, and the gearshift shaft serves for the rotationally fixed arrangement of the small-diameter gearwheel, and the hollow shaft and the gearshift shaft are provided with engagement devices which can be put in coupling engagement by means of axial movement in order to change the transmission ratio.

The lifting device designed according to the invention, due to the construction of the input shaft arrangement as a coupling device, allows a directly adjacent spatial arrangement of the large-diameter gearwheel of the output shaft and the large-diameter gearwheel of the input shaft with the smallest possible distance from one another since the large-diameter gearwheel of the input shaft arrangement, which gearwheel is arranged on the hollow shaft, runs continuously, and the control of the force flow is executed by the gearshift shaft's axial shifting movement with respect to the hollow shaft. This axially close and adjacent arrangement of the large-diameter gearwheels of the input shaft arrangement and the output shaft arrangement results in an accordingly flat structure of the lifting gear mechanism.

Based on the formation, which is independent from the driving gearwheel, of engagement devices of the coupling device, it is possible to limit the design of the engagement devices solely to the coupling function and its execution in a manner as simple as possible, without the need to design the coupling with regards for the module of the driving gearwheel.

When the driving gearwheel has a length which is dimensioned greater then an engagement distance between the engagement devices of the gearshift shaft and the engagement devices of the hollow shaft, it is ensured that the engagement devices get engaged with one another before the driving gearwheel is out of engagement with the output shaft arrangement. Thus it can not happen that a gear position occurs in which the force flow is interrupted.

When, in addition, the hollow shaft of the input shaft arrangement and the output shaft arrangement each have a congruent diameter in the area of the large-diameter gearwheel, it is possible that for the hollow shaft of the input shaft arrangement as well as for the output shaft arrangement, gearwheels having identical bores can be used, which has an accordingly positive effect on the manufacturing costs.

When, in addition, the large-diameter gearwheels have a congruent outer diameter and a congruent module, the large-diameter gearwheels can be designed identical so that this involves a reduced number of different parts of the lifting device or the lifting gear mechanism, respectively, which results in further cost savings.

The cost saving opportunities become particularly effective during manufacturing when the large-diameter gearwheels are composed of congruently formed annular disk elements so that the number of different parts can still be reduced further.

When each of the engagement devices are formed as a cam device with at least one driver cam, which are engaging with one another during an appropriate relative rotation of the gearshift shaft and the hollow shaft, a shifting operation for transmitting the lifting gear mechanism from a low gear, in which the small driving gearwheel of the input shaft arrangement meshes with the large-diameter gearwheel of the output shaft arrangement, into a fast gear, in which the large-diameter gearwheel of the input shaft arrangement meshes with the small-diameter gearwheel of the output shaft arrangement, can be executed particularly easily since, corresponding to the angular offset of the driver cams, the probability is very high that the shifting operation can be executed without a mutual blocking of the driver cams, independently from the relative rotational angle position of the hollow shaft with respect to the gearshift shaft. In the fast gear, the load to be transmitted is very low so that for load transmission, an engagement between few cams is sufficient to allow a safe force transmission. On the other hand, during shifting from the fast gear position into the low gear position, the probability is high that the teeth of the small-diameter driving gearwheel (pinion) do not engage at the first trial into the appropriate engagement gaps between the teeth of the large-diameter driven gearwheel of the output shaft arrangement. However, it is possible to rotate the gearshift shaft without load between the stops of the driver cams so that a teeth engagement can be made without a high number of unsuccessful attempts. Because of the specified self-locking construction of the thread of spindle nut and lifting spindle, the unloaded condition of the gearshift shaft is construction-related.

It has proven to be particularly simple and can hence be implemented cost efficiently, when the cam device of the gearshift shaft is formed from a driver pin which penetrates the gearshift shaft radially, and the ends of which project radially beyond the gearshift shaft diameter and form driver cams.

For a function-complementary formation of the cam device of the hollow shaft, it has proven to be advantageous when the cam device consists of two driver cams which are arranged offset by 180 degrees on the inner circumference of the hollow shaft.

In particular in case of a formation of the hollow shaft as a molded part, for example as a casting or a deep-drawn part, it has proven to be advantageous when the driver cams are formed integral with the hollow shaft.

For increasing of the operational safety of the lifting device, it is advantageous when the gearshift shaft in the transport configuration of the lifting device in the low gear position penetrates two adjacent wall regions of the shank tube and the support tube, thus forming an additional run-down protection to avoid that the support tube, for example due to vibrations, runs down on the lifting spindle during driving of the vehicle.

Hereinafter a preferred embodiment of the lifting device is explained in more detail by means of the drawing.

### IN THE FIGURES

FIG. 1 shows a lifting device in a front view;

FIG. 2 shows the lifting device illustrated in FIG. 1 in a sectional view along the section line II-II in FIG. 1;

FIG. 3 shows a shank tube of the lifting device illustrated in FIG. 1 in a cross-sectional view;

FIG. 4 shows an alternative cross-sectional form of the shank tube cross section illustrated in FIG. 3;

FIG. 5 shows an enlarged illustration of the lifting gear mechanism according to FIG. 2;

FIG. 6 shows an individual illustration of a hollow shaft of an input shaft arrangement illustrated in FIG. 5 in a side view;

FIG. 7 shows the hollow shaft illustrated in FIG. 6 in a perspective view.

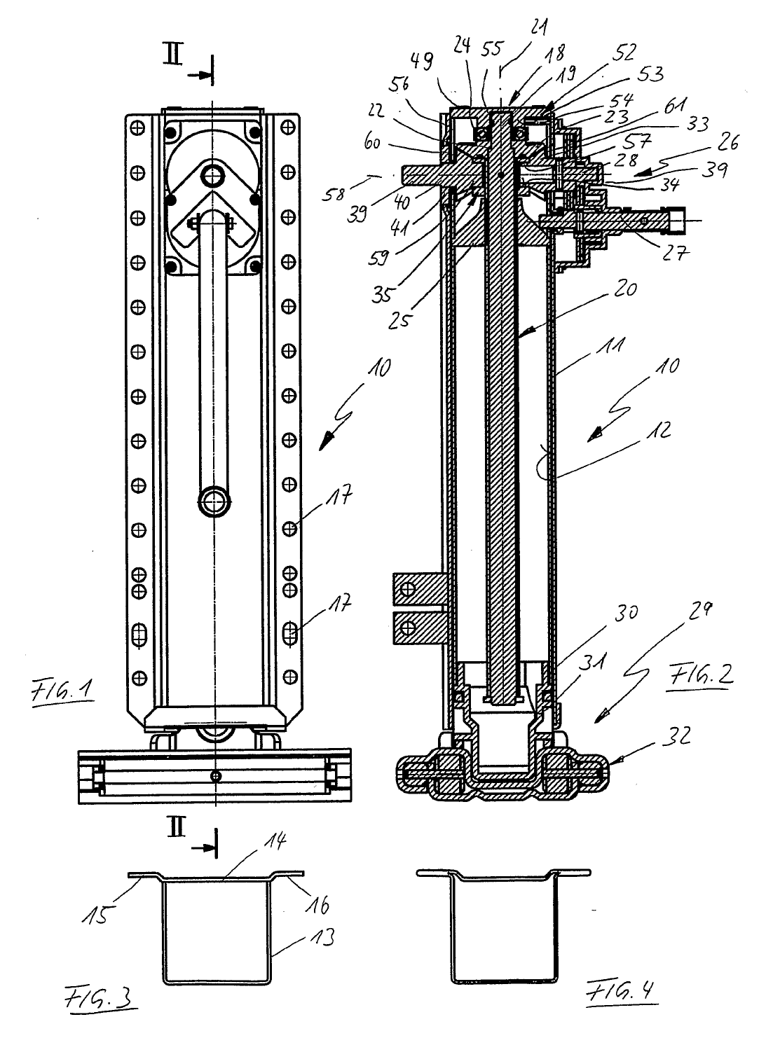

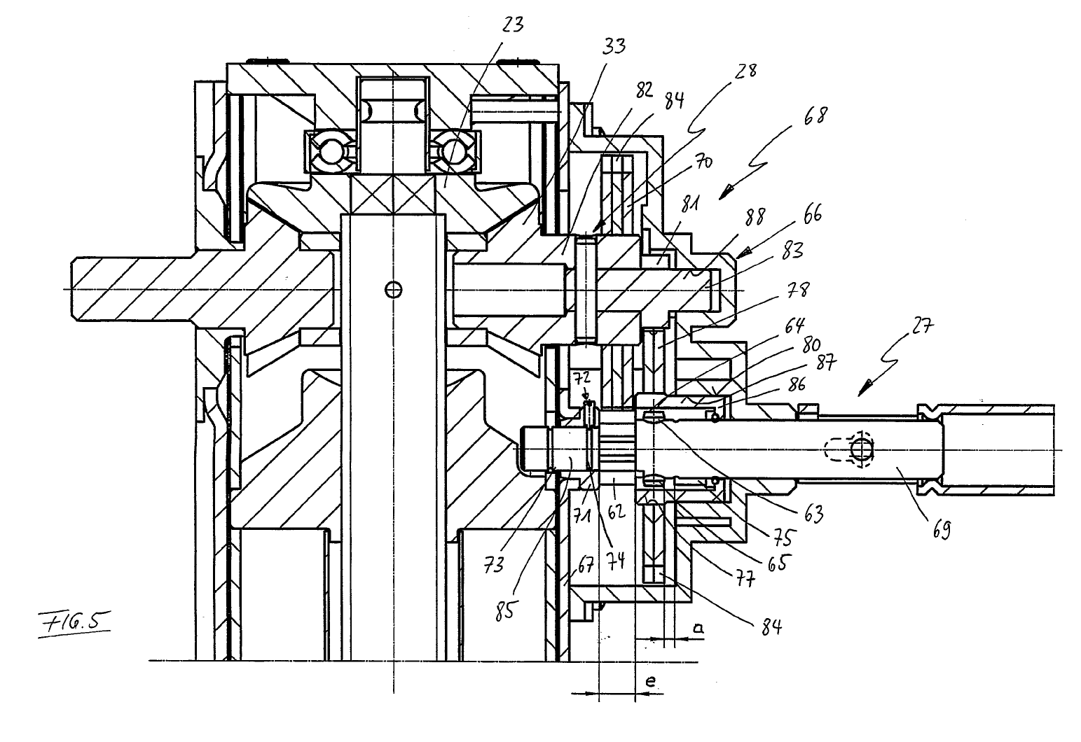

From an overview of FIG. 1 and FIG. 2, the structure of a lifting device 10 comprising a shank tube 11 and a support tube 12 coaxially arranged within the shank tube 11 is apparent. According to the embodiment illustrated in FIG. 3, the shank tube 11 consists of a U-shaped shank tube profile 13 and a mounting plate 14, which completes the profile 13 to form a square tube, and which forms at the same time the back wall of the shank tube 11. The mounting plate 14 serves for connection to a vehicle chassis and, on connection rails 15, 16 formed on the side, comprises a plurality of mounting bores 17 which allow a connection to differently formed vehicle chassis, or in different mounting heights on a vehicle chassis, respectively.

As is apparent in particular from the sectional view illustrated in FIG. 2, the support tube 12 received in the shank tube 11 extends substantially over the entire length of the shank tube 11. As is further shown in FIG. 2, as a quasi front-end closure, the shank tube 11 comprises a pressure plate 18, which serves for receiving an upper lifting spindle end 19 of a lifting spindle 20 which extends on a longitudinal axis 21 of the lifting device 10 or the support tube 12, respectively. Furthermore, at the upper lifting spindle end 19, a lifting spindle gearwheel 23 is located, which is arranged torque-proof on a shaft collar 22, and which serves for driving the lifting spindle 20, and, together with the lifting spindle 20, rests against the pressure plate 18 via an axial bearing 24.

Arranged on the lifting spindle 20 is a spindle nut 25, which on its circumference is connected in a rotationally fixed manner with the support tube 12 so that a rotation of the lifting spindle 20 due to a driving of the lifting spindle gearwheel 23 via the thread engagement of the lifting spindle 20 with the spindle nut 25, depending on the direction of rotation, causes an extending or retracting of the support tube 12 out of or into the shank tube 11.

For driving the lifting spindle gearwheel 23 serves a lifting gear mechanism 26 which is arranged below the pressure plate 18 and which comprises an input shaft arrangement 27 and an output shaft arrangement 28 which acts on the lifting spindle gearwheel 23.

At the lower end of the support tube 12, a foot device 29 is located, which comprises a foot receptacle 31 connected with the lower front end 30 of the support tube 12, as well as a pivoting foot 32 connected with the foot receptacle 31.

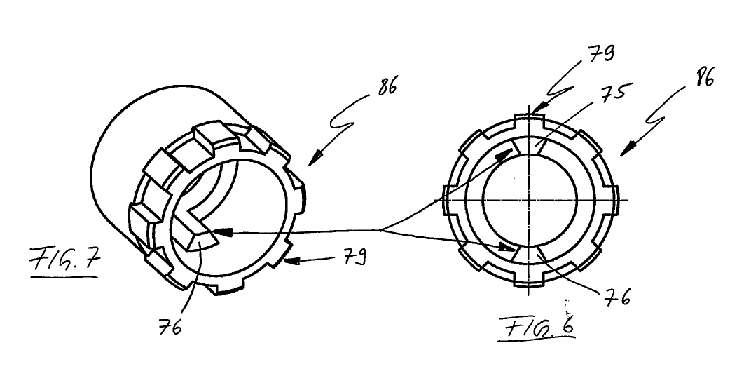

The lifting gear mechanism 26 illustrated on an enlarged scale in FIG. 5 includes the input shaft arrangement 27, comprising a gearshift shaft 85 and a hollow shaft 86 arranged coaxially to the gearshift shaft 85. In the present case, on the gearshift shaft 85, a small-diameter driving gearwheel 62 is formed integral with the gearshift shaft. Arranged with an axial distance to the driving gearwheel 62 is a driver pin 63, which in the present case is inserted into the gearshift shaft 85 and which, by means of each of the two ends projecting beyond the outer diameter of the gearshift shaft 85, forms a driver cam 64 and 65, respectively. The gearshift shaft 85 projects with its shaft end facing away from the lifting spindle 20 out of a housing cover 66 of a gearing housing 68 formed by the housing cover 66 and the shank tube wall region 67. The shaft end projecting out of the gear housing 68 is formed as a connection end 69 for connecting a crank drive or another appropriate drive device.

The gearshift shaft 85 designed as an input shaft is in the position illustrated in FIG. 5 in the “low gear position” in which the driving gearwheel 62 meshes with a large-diameter driven gearwheel 70 of the output shaft arrangement 28. In the “low gear position”, the gearshift shaft's 85 end facing towards the lifting spindle 20 is guided through overlapping tube wall regions of the shank tube 11 and the support tube 12 into the support tube 12. For the definition of different shift positions, in the region of a shaft bearing 71 arranged in the wall of the shank tube 11, a latching device 72 is provided, which in a spring-loaded manner snaps into latching grooves 73, 74 of the gearshift shaft 85.

In the illustrated “low gear position”, starting with the small-diameter driving gearwheel 62 of the gearshift shaft 85, via the large-diameter driven gearwheel 70 of the output shaft arrangement 28, the lifting spindle driving gearwheel 33 is driven, and by means of this one, the lifting spindle gearwheel 23 for driving the lifting spindle 20 is driven. To change the shift position from the “low gear shift position” into the “fast gear shift position”, the input shaft's 27 gearshift shaft 85 designed as an input shaft is pulled out of the gear housing 68 until the latching device 72 snaps into the latching groove 73. In this shift position, the gearshift shaft's 85 shaft end facing towards the lifting spindle 20 is then located outside of the support tube 12.

Furthermore, the driver cams 64, 65 of the gearshift shaft 85 are located in the “fast gear shift position” in the region of driver cams 75, 76, which are formed on the inner circumference of the hollow shaft 86, and which are illustrated in the FIG. 6 or 7, respectively, in more detail. In the present case, the driver cams 75, 76 of the hollow shaft 86, as well as the driver cams 64, 65 of the gearshift shaft 85 are radially offset by 180 degrees. On a hub region 77 of the hollow shaft 86, a large-diameter driving gearwheel 78 of the input shaft arrangement 27 is arranged in a rotationally fixed manner. For this, the hollow shaft 86 in the present case, as illustrated in FIGS. 6 and 7, comprises a spline profile 79. Adjacent to the hub region 77 of the hollow shaft 86, the hollow shaft 86 comprises a bearing collar 80 by means of which the hollow shaft 86 is rotatably supported in the housing cover 66 in an overhung position.

The driving gearwheel 78 is in a permanent engagement with a small-diameter driven gearwheel 81 of the output shaft arrangement 28. The output shaft arrangement 28 comprises the output shaft 82 which, in the present case, serves at the same time for forming the lifting spindle driving gearwheel 33, and a bearing pin 83 which is connected with the output shaft 82 in a rotationally fixed manner, and which serves at the same time for forming the small-diameter driven gearwheel 81. For supporting the output shaft arrangement 28, the bearing pin 83 is supported in the gear housing cover 66, and the output shaft 82 is supported in the bearing device 35.

In the “fast gear shift position”, the small driving gearwheel 62 is out of engagement with the large-diameter driven gearwheel 78, and the driver cams 64, 65 of the gearshift shaft 85 are in engagement with the driver cams 75, 76 of the hollow shaft 86 so that the drive torque is transmitted from the gearshift shaft 85 via the hollow shaft 86, the large-diameter driving gearwheel 78, and the small-diameter driven gearwheel 81 to the output shaft arrangement 28. In the “fast gear shift position”, the large-diameter driven gearwheel 70 rotates without load together with the output shaft 82.

As shown in FIG. 5, the large-diameter driving gearwheel 78 and the large-diameter driven gearwheel 70 consist of annular disk elements 84, each of them identical to one another, and each of them forming a disk-shaped gearwheel segment. The different number of annular disk elements 84 is chosen corresponding to the different load on the gearwheels 78 and 70 in the low gear or fast gear, respectively.

The gear housing cover 66 is preferably made from a material with good sliding characteristics, thus, for example, a suitable cast or sinter material, or preferably also a plastic material. Hence, the hollow shaft 86 and the bearing pin 83 of the output shaft arrangement 28 can be supported directly and without use of separate bearing bushes, or the like, in bearing receptacles 87 and 88 formed within the housing cover 66.

1-10. (canceled)

11. A lifting device, in particular a semitrailer support or the like, comprising a shank tube and a support tube which is movable with respect to the shank tube, wherein on the shank tube a lifting gear mechanism is arranged which comprises an input shaft arrangement for connecting a drive device, and an output drive arrangement for driving a lifting spindle which is arranged within the support tube, wherein the input shaft arrangement and the output shaft arrangement each comprise at least one large-diameter gearwheel and one small-diameter gearwheel which can be put in force-fitting engagement with one another to generate different transmission ratios, characterized in that
the input shaft arrangement comprises a hollow shaft supported in a gear housing and an axially movable gearshift shaft which is arranged coaxially with respect to the hollow shaft and which is supported in the gear housing, wherein the hollow shaft serves for the rotationally fixed arrangement of the large-diameter gearwheel, and the gearshift shaft serves for the rotationally fixed arrangement of the small-diameter gearwheel, and the hollow shaft and the gearshift shaft are provided with engagement devices which can be put in coupling engagement by means of axial movement in order to change the transmission ratio.

12. The lifting device according to claim 11, wherein
the driving gearwheel has an engagement length e which is dimensioned greater then an engagement distance a between the engagement devices of the gearshift shaft and the engagement devices of the hollow shaft.

13. The lifting device according to claim 1, wherein
the hollow shaft of the input shaft arrangement and the output shaft arrangement each have a congruent diameter in the region of the large-diameter gearwheel.

14. The lifting diameter according to claim 13, wherein
the large-diameter gearwheels have a congruent outer diameter and a congruent module.

15. The lifting device according to claim 14, wherein
the large-diameter gearwheels consist of congruently formed annular disk elements.

16. The lifting device according to claim 1, wherein
each of the engagement devices are formed as a cam device with at least one driver cam which, during an appropriate relative rotation of the gearshift shaft and the hollow shaft, get into engagement with one another.

17. The lifting device according to claim 16, wherein
the cam device of the gearshift shaft is formed from a driver pin which radially penetrates the gearshift shaft, and the ends of which radially project beyond the gearshift shaft diameter and form driver cams.

18. The lifting device according to claim 16, wherein
the cam device of the hollow shaft consists of two driver cams arranged offset by 180 degrees on the inner circumference of the hollow shaft.

19. The lifting device according to claim 18, wherein
the driver cams are formed integral with the hollow shaft (86).

20. The lifting device according to claim 1, wherein
the gearshift shaft, in low gear position and in transport configuration of the lifting device, penetrates two adjacent wall regions of the shank tube and the support tube.
